(19) United States
(12) Patent Application Publication
(10) Pub. No.: US 2014/0109990 A1
(43) Pub. Date: Apr. 24, 2014

(54) Remotely mounted irrigation control system

(71) Applicant: Toby Brashear, Punta Gorda, FL (US)

(72) Inventor: Toby Brashear, Punta Gorda, FL (US)

(21) Appl. No.: 13/694,002

(22) Filed: Oct. 19, 2012

(51) Int. Cl. F16L 3/00

(52) U.S. Cl. 137/343

(57) ABSTRACT

A remotely mountable irrigation unit which can be mounted in any location desired by the user, or due to system constraints, which utilizes quick disconnects, for ease of installation or moving to another location. The preferred embodiment of the present invention centralizes all of an irrigation systems control valves, wiring, and includes the irrigation control unit, thus ensuring ease of maintenance and installation. The unit may be controllable via personal computer, laptop, smartphone, or tablet allowing the user to program all aspects of the system, from zone irrigation duration, to which zones receive irrigation at what time, and observe system performance such as power consumption, fluid consumption, and determine if there are any leaks in the system via pressure drops sensed at one of the valves.

### FIELD OF USE

The present invention relates to a grounds irrigation system, wherein the control valves, wiring harness, and irrigation control unit, for ease of maintenance and use, are mounted in a weather proof box, with a removable, notched cover which is mounted to any preferred surface, be it the side of a building, tree, pole, or other mounting point. The irrigation control unit; of the present invention; being remotely controlled via computer, laptop, smartphone, or tablet.

### BACKGROUND OF THE INVENTION

Prior approaches to irrigation control typically have the control valves and associated hardware buried underground near the sprinkler head with said control valve controls. This is undesirable as installation, maintenance, and purging the system for winterizing are more labor intensive and costly.

Some prior art irrigation control units include:
U.S. Pat. No. 7,406,363 (Doering, et al.) discloses an irrigation controller and a software program product for generating valve control signals for energizing a valve. The irrigation controller includes a valve actuation control module selectively coupled to each of a plurality of control nodes and generating a valve actuation control signal thereon. The valve actuation control signal is a continuous control voltage over a plurality of control signal periods for selectively energizing the selected irrigation valve.
U.S. Pat. No. 7,004,677 (Ericksen et al.) discloses a valve containment assembly for an irrigation system with a first side wall unit, a grate, a second side wall unit, and a lid. The first side wall unit is disposed on the floor of a hole. The grate is positioned in the first side wall unit to support a manifold. The second side wall unit rests on the first side wall unit to cover the manifold and the lid is disposed on top of the side wall unit. The first side wall unit and the grate elevate the manifold above the floor of the hole to reduce interference of soil and water with the manifold. Additional side wall units may be used to provide additional height. Any of the side wall units may have frangible portions that break away to permit passage of conduits into the valve containment assembly.
U.S. Pat. No. 6,834,662 (Olson et al.) discloses an improved automated sprinkler system. A pre-assembled housing or valve box includes an inlet for receiving water and one or more outlets for the distribution of water to other components in the irrigation system, and also includes manifold and power and valve means for selectively controls the flow of water from the outlets. Many of the manifold components are integrally molded with each other and provided in modular form so that the system can be relatively compact and can be customized into a variety of configurations. The manifold includes integrally formed or interconnected valve bases.

The object of the remotely mountable irrigation control unit of the present invention is to enable for ease of installation, and maintenance of irrigation systems for grounds keeping. The use of this remotely mountable irrigation control unit will enable the installer to provide a longer warranty to the customer. Prior approaches have the sprinkler head control valves buried underground near the sprinkler head which is being controlled. This is undesirable as maintenance and system trouble shooting is very difficult, requiring much more work than the object of present invention. In addition, the amount of wiring necessary between the zone timer and control valve is greatly reduced. There is the added bonus of the prevention of burrowing animals from wreaking havoc on the system by chewing through the wiring and causing failures which can require a fair amount of trouble shooting to discover. The control valve is attached to the manifold assembly via a quick disconnect coupler so as to facilitate quick changes of the control valves if any fail or to install a straight pipe if such a change were necessary due to changes in irrigation specifications.

Another object of the remotely mountable irrigation control unit of the present invention is a manifold system comprising control valves, mounted in a wall mountable unit. The spacing of the valves in the manifold and manifold bracket is important. The manifold and manifold bracket must be constructed with spacing to insure that each valve can be spun and removed without interfering with the valves on either side of the valve that must be replaced. This invention will allow for any size valve.

Another objective of the remotely mounted irrigation control unit of the present invention is to enable the valves and controller to be prewired with a specific wiring harness that uses weather proof or non-weather proof connectors and specific wiring protection and covering, such as convoluted conduit. The wiring harness is located in the manifold for protection and routing.

Yet another object of the remotely mountable irrigation control unit of the present invention is weather proof, remotely mountable, control box whereby said control valves, manifold, and irrigation control are placed inside.

Still another object of the remotely mountable irrigation control unit of the present invention relates to the control being accessible for repairs, calibration or maintenance while the owner is not home, allowing the maintenance technician to be able to perform any of the previously mentioned functions without inconveniencing the owner by requiring the owner to come home from work or other activities.

What is needed is a remotely mountable irrigation control system wherein installation, maintenance, system trouble shooting, winterizing and system zone control is more easily performed. This system is designed to accept any size valve, any size pipe, and any size controller. It is further designed to accept valves, pipes and controllers from any manufacturer. For example, any 1″ valve with female threads on the intake and discharge may be used, enabling cost to be minimized while simplifying maintenance and increasing valve life as the effects of being buried underground are eliminated.

Lastly, what is needed is an irrigation control unit which may be remotely accessed via personal computer or smart phone, allowing the user to program zone watering and duration and to monitor system performance, such as fluid consumption, power consumption, and individual valve performance.

### SUMMARY OF THE INVENTION

The remote mountable irrigation control unit of the present invention addresses these objectives and these needs.

The remotely mountable irrigation unit of the present invention can be mounted in any location desired by the user, or due to system constraints, which utilizes quick disconnects, for ease of installation or moving to another location. The preferred embodiment of the present invention centralizes all of an irrigation systems control valves, wiring, and includes the irrigation control unit, thus ensuring ease of maintenance and installation. The unit may be controllable via personal computer, laptop, or smart phone, allowing the user to program all aspects of the system, from zone irrigation duration, to which zones receive irrigation at what time, and observe system performance such as power consumption, fluid consumption, and determine if there are any leaks in the system via pressure drops sensed at one of the valves. This software enables the user to manually turn off individual valves in the case of leaks or sprinkler head failure.

The remote mountable irrigation control unit of the present invention enables the installer to provide a longer warranty to the customer. The spacing of the valves in the manifold and manifold bracket is important. The manifold and manifold bracket must be constructed with spacing to insure that each valve can be spun and removed without interfering with the valves on either side of the valve that must be replaced. This invention will allow for any size valves.

The remote mountable irrigation control unit of the present invention is designed to accept any size valve, any size pipe, and any size controller. It is further designed to accept valves, pipes and controllers from any manufacturer. The manifold bracket, for each version and size of enclosure, is designed with a notch at the top, back edge of the bracket, as seen in drawing 5A. This notch enables a lift off cover to be used without a door. This is for the low cost version of enclosure but is preferably present on all manifolds even when the enclosure, with a door, is used. It enables shrubs or bushes to be planted nearby the enclosure while still enabling access to the irrigation components for service, repair, or the installation of new parts. The bottom of the closeout cover is designed with slots or notches to enable the pipes to enter and exit the enclosure while keeping small animals and insects out of the enclosure.

The remote mountable irrigation control unit includes: said weather proof box, manifold, control valves, quick disconnect couplers, and irrigation control unit. The present invention is assembled and affixed to whichever surface is preferrable given a particular installation, which in many cases will be the side of a building or domicile or even a pole.

For a complete remote mountable irrigation control unit of the present invention, reference is made to the following summary of the invention detailed description and accompanying drawings in which the presently preferred embodiments of the invention are shown by way of example. As the invention may be embodied in many forms without departing from spirit of essential characteristics thereof, it is expressly understood that the drawings are for purposes of illustration and description only, and are not intended as a definition of the limits of the invention.

### BRIEF DESCRIPTION OF THE DRAWINGS

FIG. 1 depicts a first preferred embodiment of the remotely mounted irrigation control system [10] of the present invention, showing the remotely mounted irrigation control unit [10], the manifold bracket [12], the irrigation control unit [16], and the irrigation control valve [17].

FIG. 2A depicts the first preferred embodiment of the remotely mounted irrigation control system [10] of FIG. 1 with the control valve assembly [17], the control unit [16], and PVC plumbing [13], installed into the weather proof box; FIG. 2B depicts the preferred embodiment of the remotely mounted irrigation control system [10], with control valve assembly [17], and PVC plumbing [13], installed in the weather proof box minus the control unit; FIG. 2C depicts the preferred embodiment of FIG. 1 from the side profile view wherein the manifold bracket [12], and control unit [16] is visible; FIG. 2D depicts the preferred embodiment of the present invention from the top view wherein the control valve assembly [17], PVC plumbing [13] and manifold bracket [12] are visible; and FIG. 2E depicts the preferred embodiment of the enclosure minus the door.

FIG. 3A depicts the rear view of the preferred embodiment of the remotely mounted irrigation control system [10] with the door open and the latch [18] visible; FIG. 3B depicts the side view of the preferred embodiment of the present invention wherein the door is open; and FIG. 3C depicts the side view of the preferred embodiment of the present invention with the door [19] closed and the irrigation plumbing opening [20].

FIG. 4A depicts the preferred embodiment of the remotely mounted irrigation control system [10] in a profile view, in a scaled down version with the control valve [17], and manifold bracket [12] clearly visible; FIG. 4B depicts the frontal view of the preferred embodiment the remotely mounted irrigation control system [10], again scaled down, with the control valve [17], and the manifold bracket [12] visible; and FIG. 4C depicts the frontal view of the preferred embodiment the remotely mounted irrigation control system [10], again scaled down, with the control valve [17], and PVC tubing [13] being visible.

FIG. 5A depicts the top view of the manifold bracket [12] depicting the notch needed for installation; FIG. 5B depicts the front view of the manifold bracket [12]; FIG. 5C depicts the bottom view of the manifold bracket [12]; FIG. 5D depicts the end view of the manifold bracket [12]; FIG. 5E depicts a section view through the upper portion of FIG. 5B; and FIG. 5F depicts a section view through the lower portion of FIG. 5B.

FIG. 6 depicts the profile view of the manifold bracket [12] with valves [17], in-line connectors [22], convoluted tubing [20], wiring bundle [24] and irrigation control unit [16] of another preferred embodiment of the remotely mounted irrigation control system [10] of the present invention.

FIG. 7 depicts an exploded assembly view of the notched irrigation control unit cover [26] of the preferred embodiment of the remotely mounted irrigation control system bracket [12] with the notch.

FIG. 8 depicts yet another preferred embodiment of the remotely mountable irrigation unit [10] with the fluid intake pipe [30] feeding into a primary and secondary irrigation unit [32] combination.

### DETAILED DESCRIPTION OF THE PREFERRED EMBODIMENTS

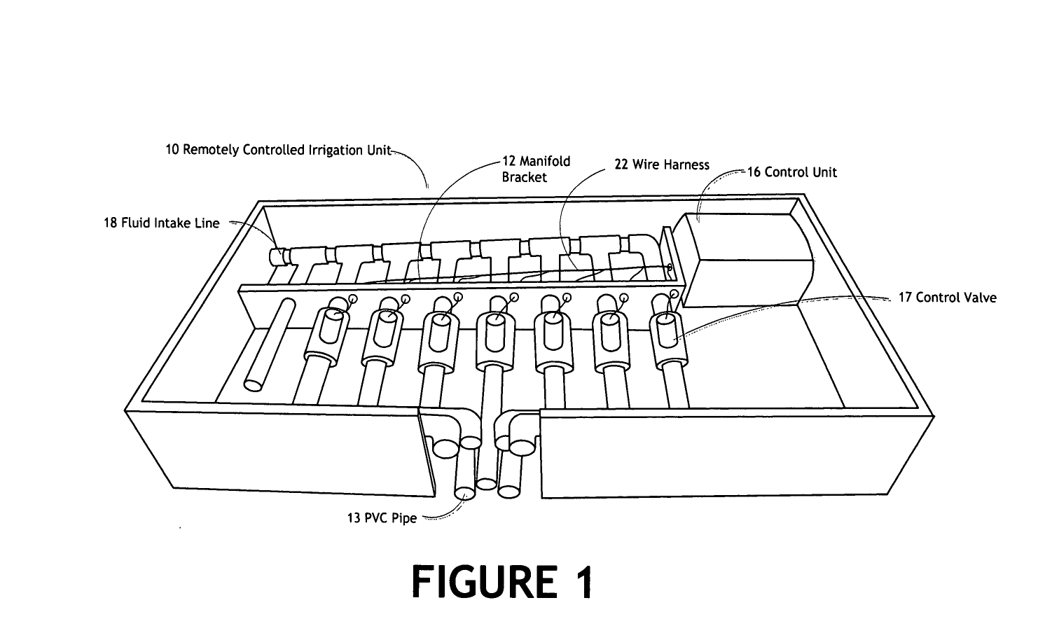

Referring to the drawings, FIG. 1 discloses the preferred embodiment of the present invention as it would appear in a real world installation with the remotely mounted irrigation control unit [10], irrigation control valves [17], manifold bracket [12], PVC tubing [13], and the irrigation unit [16]. As is seen, the unit is modular in construction and irrigation control valves [17] can be added, or deleted depending on the needs of a particular application.

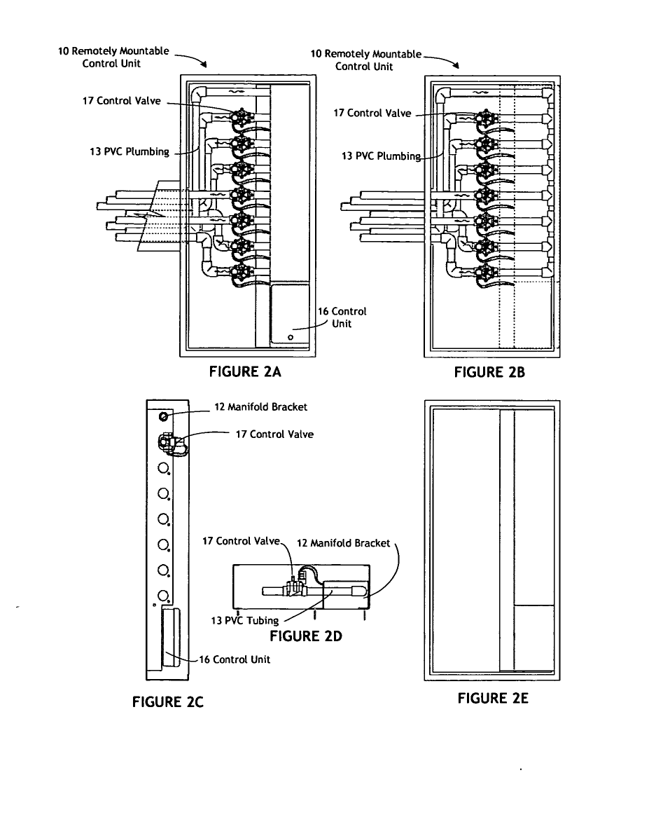

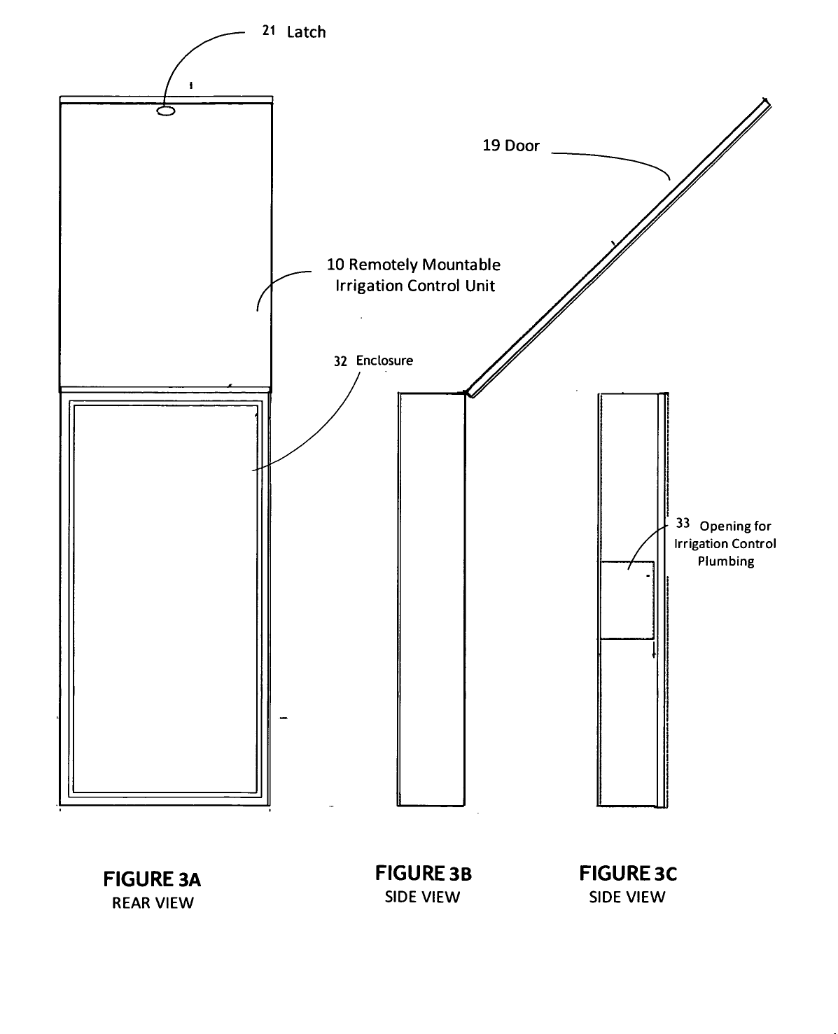

FIGS. 2A through 2E, and FIGS. 3A through 3C disclose the preferred embodiment of the remotely mounted irrigation control unit [10] of the present invention. The front of the irrigation control unit comprises a weather proof door [19], while located inside of the unit are mounted the irrigation control valves [17], irrigation control unit [16], manifold bracket [12] and PVC tubing [13] said control valves [17] are affixed to. FIGS. 3A, and 3B, depict the rear and side view of the preferred embodiment of the present invention with the weather proof door assembly, comprising the door [19] and latch [18] in the open position while FIG. 3C depicts the preferred embodiment of the present invention from the side view with the weather proof door assembly, comprising the door [19] and latch [18] closed and the opening for the irrigation control unit plumbing [20]. Once the unit is assembled and mounted in the preferred position, all aspects of irrigation will be controllable from said unit. Everything from setting individual zone control, being able to diagnose failed/failing control valves and teaks associated with improper valve installation from one location instead of having to dig up every valve to trouble shoot failures or leaks.

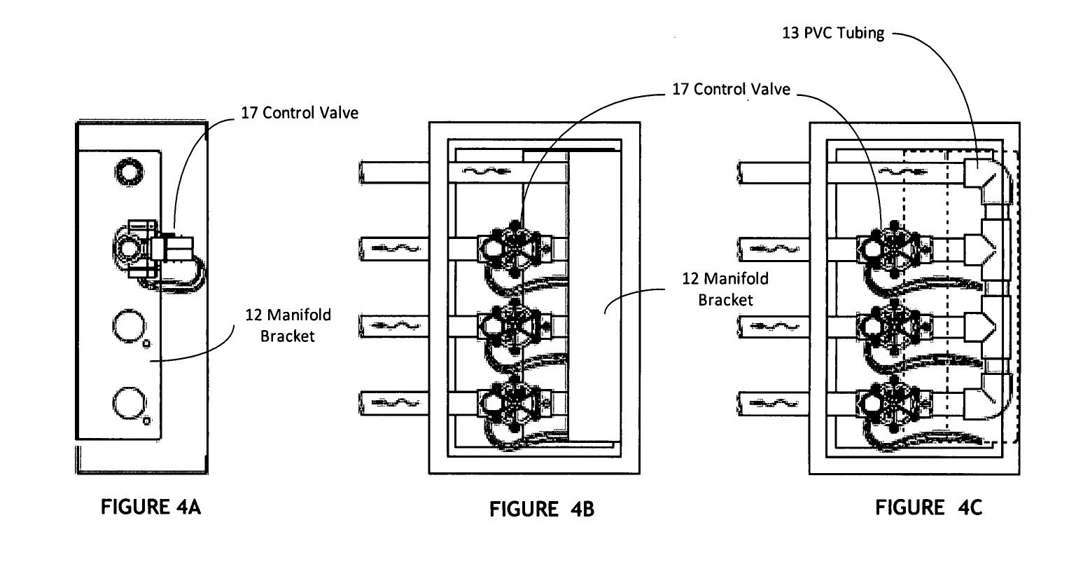

FIGS. 4A, 4B, and 4C, depict another application of the irrigation control unit of the present invention. In this embodiment, no control valve is disposed in this unit. This enables the unit to be transferred from one location to another via the use of quick disconnects, enabling the unit to be disconnected from one set of sprinklers and be moved to a new location and quickly connected. This saves considerable time, and money as a user can simply move the unit to a new location if a given area has been irrigated and another area now needs irrigation. This saves enormous setup and assembly cost as the existing unit can be plugged in and the zones reprogrammed.

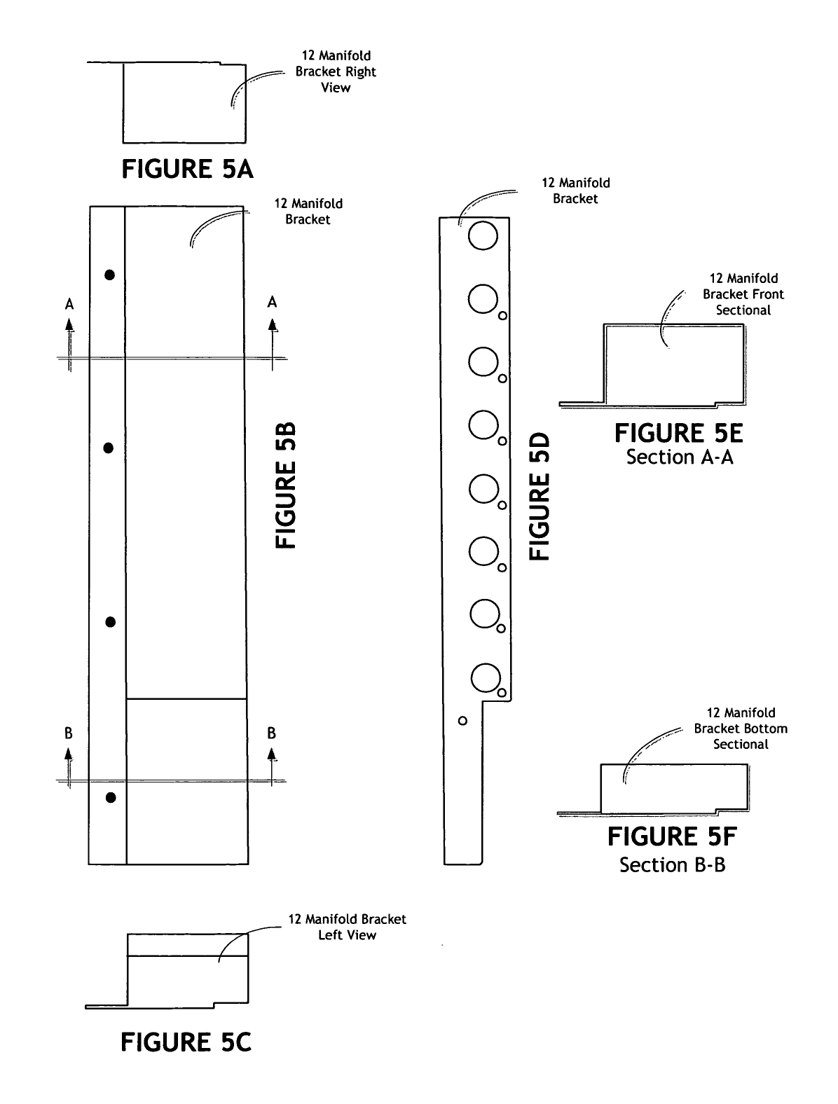

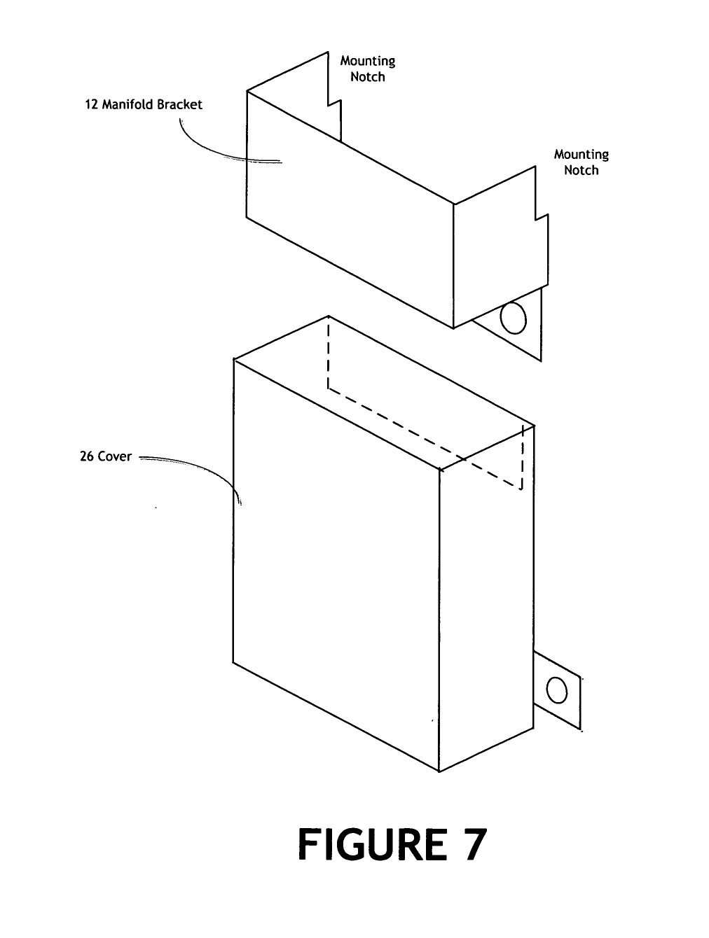

FIG. 5A depicts the top view of the manifold bracket [12] depicting the notch needed for installation. FIG. 5B depicts the front view of the manifold bracket [12]. FIG. 5C depicts the bottom view of the manifold bracket [12]. FIG. 5D depicts the end view of the manifold bracket [12]. FIG. 5E depicts a section view through the upper portion of FIG. 5B, and FIG. 5F depicts a section view through the lower portion of FIG. 5B. FIG. 7 depicts an assembly view of the notched control unit cover [26] so as to improve access and ease of maintenance.

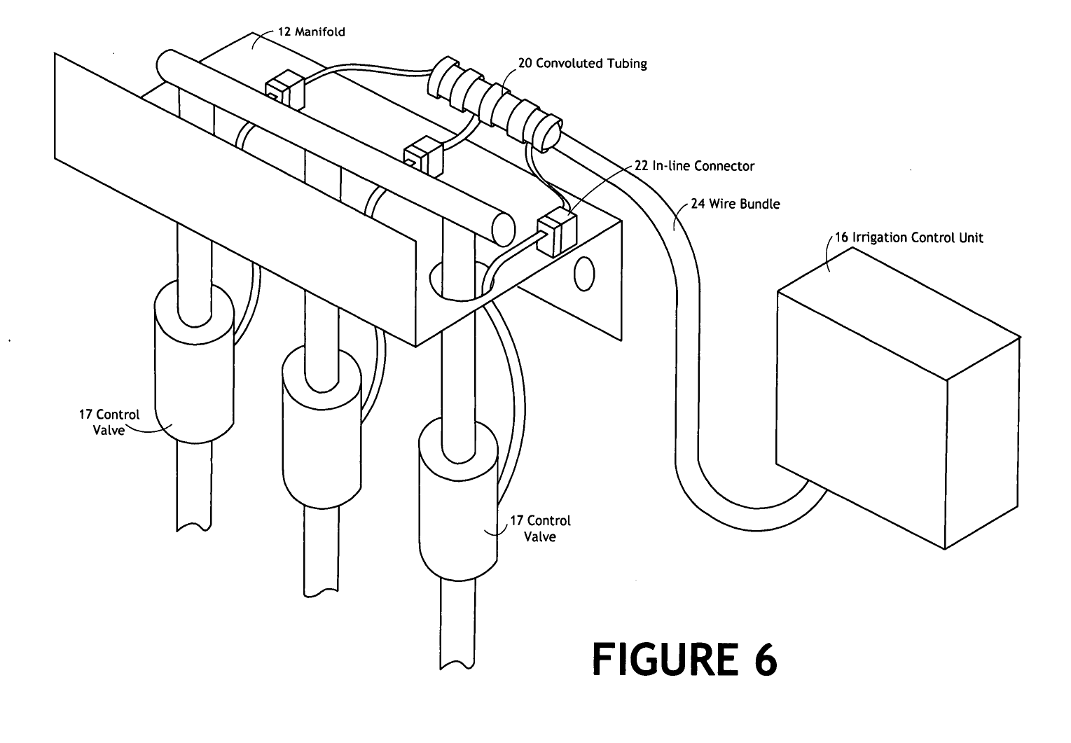

FIG. 6 depicts a profile view of the assembled manifold bracket [12] with control valves [17], in-line connectors [22], convoluted tubing [20], wiring bundle [24], and irrigation control unit [16] with the wiring bundle [24] being routed through the mounting bracket [12] so as facilitate ease of installation and maintenance. This is but one of the preferred methods of installation and can be altered depending on customer needs, such as adding more control valves [17] or reducing the number of control valves [17].

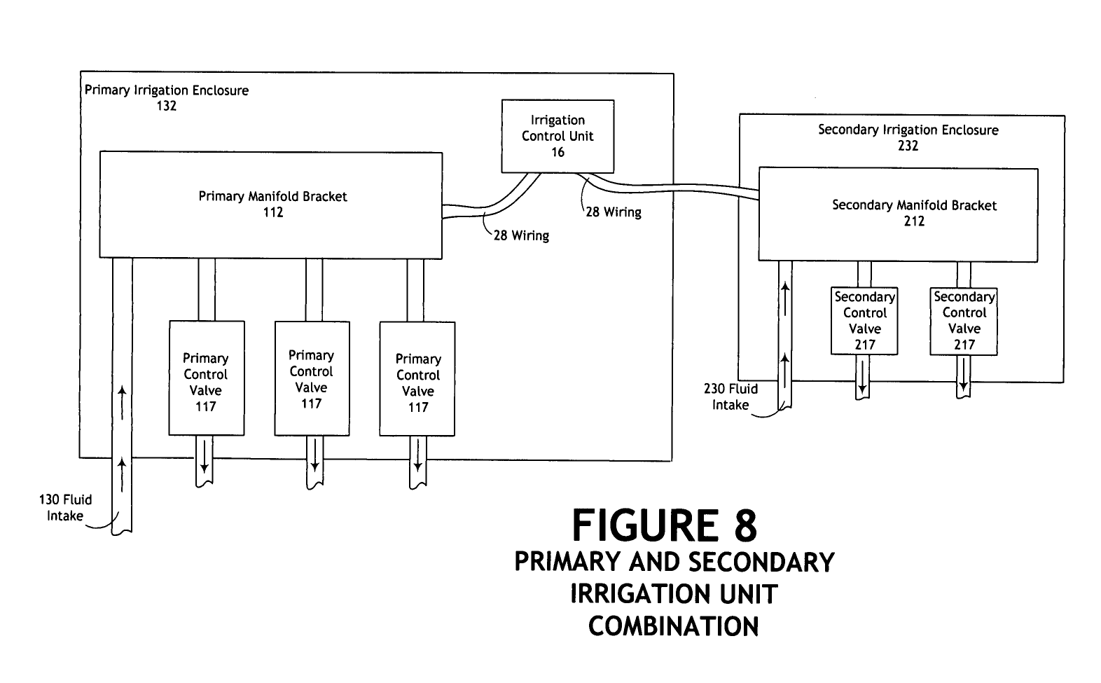

FIG. 8 depicts yet another preferred embodiment of the irrigation control unit of the present invention, including a fluid intake pipe [130] feeding into a primary and secondary irrigation unit [110 and 210] combination. The complete remotely mountable secondary irrigation control unit [210] with the layout of the primary control valves [117] in relation to the primary manifold [112] with the addition of a secondary irrigation control unit [210], and wiring [28] used to connect the secondary irrigation control unit [210], which will act as a backup in case the first unit fails, or in case additional capacity is needed for the addition of more sprinklers. The fluid intake [230] is also showing here with fluid flowing up into the PVC pipe [30] and down through the secondary control valves [217] and to the sprinkler heads (not shown).

Installation time and cost are greatly reduced since the unit can be pre-assembled off site to a customer's specifications.

Winterizing of the present invention is greatly eased as purging of the valves is insured since they are above ground and easily accessed. Also, much less wiring is used as a result of the valves and control unit being centrally located which will increase system reliability by having less wiring underground susceptibility to animals and wear and tear caused by exposure to elements and grounds maintenance.

The enclosure and all of its components can be made out of a variety of materials including, but not limited to, steel, aluminum, fiberglass, plastic and wood. These materials are used for purposes of illustration only of the wide variety of materials that can be used.

Another variation involves the control unit itself, having the ability to be accessed remotely, via the cloud, a user could remotely program the zone irrigation and irrigation duration via computer, smart phone, and tablet. Alerts could be also be setup to alert the user to fluid usage, and problems with the system, for example of there is a pressure drop in a given valve indicating the possibility of a leak at a given sprinkler head. This would allow the user to turn off individual control valves, preventing the geysers one sees when a sprinkler head has been failed, and preventing the fluid from flowing through a ruptured portion of irrigation line, potentially ruining the turf, or garden or other area being irrigation.

Throughout this specification, there are various patent are referenced by application number and inventor. The disclosures of these patents are hereby incorporated by reference in their entireties into this specification in order to more fully describe the state-of-the-art.

It is evident that many alternatives, modifications, and variations of the remotely mountable irrigation control unit of the present invention will be apparent to those skilled in the art in light of the disclosure herein. It is intended that the metes and bounds of the present invention be determined by the appended claims rather than by the language of the above specification, and that all such alternatives, modifications, and variations which form a conjointly cooperative equivalent are intended to be included within the spirit and scope of these claims.

### PARTS LIST

10. Remotely Mountable Irrigation Control Unit
12. Manifold Bracket
13. PVC Pipe
16. Control Unit
17. Control Valve
18. Enclosure
19. Door
20. Convoluted Tubing
21. Latch
22. In-line Connector
24. Wire Bundle
26. Enclosure Cover
28. Wiring
30. Fluid Intake
32. Enclosure
33. Opening for Irrigation Control Plumbing
110. Primary Irrigation Unit
112. Manifold Bracket
117. Control Valve
118. Enclosure
130. Fluid Intake
210. Secondary Irrigation Unit
212. Manifold
218. Enclosure
230. Fluid Intake

I claim:

1. An irrigation control system for controlling the flow of fluid from a supply line to a plurality of outlet lines, said irrigation control system comprising:
a cabinet having an open position and a closed position;
a fluid intake line;
a plurality of control valves, said plurality of control valves being mounted within said cabinet;
a control unit actuating said plurality of control valves; and
a wiring harness being in electrical connection with said plurality of control valves and said control unit; and
a manifold bracket to ensure sufficient spacing between said plurality of control valves, enabling any of said plurality of control valves to be removed without abutting or interference with any other of said other plurality of control valves, said wiring harness extending through said manifold bracket to each of said plurality of control valves.

2. The irrigation control system of claim 1, wherein said enclosure includes a notch or a slot and a lift-off cover for access.

3. The irrigation control system of claim 1, wherein said irrigation control system is disposed in a sealed enclosure to enable pipes to enter and exit while essentially sealing said enclosure from small animals.

4. The irrigation control system of claim 1, wherein said irrigation control system is universal in that said irrigation control system is compatible with any size valve, any size pipe, and any conventional control unit.

5. The irrigation control system of claim 1, wherein zone, timer control, fluid consumption data, system trouble shooting and unit programming is accessed, remotely, via the cloud, smart phone, computer, laptop, tablet, or other electronic device.

6. The irrigation control system of claim 1, wherein the enclosure is made of a material selected from the group consisting of steel, aluminum, fiberglass, plastic and wood.

7. An irrigation control system mounted in an enclosure, said irrigation control system comprising:
a plurality of control valves;
a control unit actuating more than one of said control valves; and
a wiring harness being disposed through a manifold bracket, said wiring harness being in electrical connection with said plurality of control valves, said manifold bracket ensuring sufficient spacing between said plurality of control valves, enabling any of said plurality of control valves to be removed without abutting or interference with any other of said other plurality of control valves, said wiring harness extending through said manifold bracket to each of said plurality of control valves;
whereby, said irrigation control system is universal in that said irrigation control system is compatible with any size valve, any size pipe, and any conventional control unit.

8. The irrigation control system of claim 7, wherein said enclosure includes a notch or a slot and a lift-off cover for access.

9. The irrigation control system of claim 7, wherein said irrigation control system is disposed in a sealed enclosure to enable pipes to enter and exit while essentially sealing said enclosure from small animals.

10. The irrigation control system of claim 7, wherein said manifold bracket enabling no interference with any pipes, said control box, manifold bracket or said enclosure.

11. The irrigation control system of claim 7, whereby zone, timer control, fluid consumption data, system trouble shooting and unit programming are accessed, remotely, via the cloud, smart phone, computer, laptop, tablet, or other electronic device.

12. The irrigation control system of claim 7, wherein the enclosure is made of a material selected from the group consisting of steel, aluminum, fiberglass, plastic and wood.

13. An irrigation control system for controlling the flow of fluid from a supply line to a plurality of outlet lines, said irrigation control system comprising:
a primary irrigation control cabinet having an open position and a closed position; a primary fluid intake line; a plurality of primary control valves, said plurality of primary control valves being mounted within said primary irrigation control cabinet; a primary control unit actuating said plurality of primary control valves; a primary wiring harness being in electrical connection with said plurality of control valves and said control unit; a primary manifold bracket to ensure proper spacing between said plurality of control valves, enabling any of said plurality of control valves to be removed without abutting or interference with any other of said other plurality of control valves, said wiring harness extending through said manifold bracket to each of said plurality of control valves; and
a secondary irrigation control cabinet having an open position and a closed position; a secondary fluid intake line; a plurality of secondary control valves, said plurality of secondary control valves being mounted within said secondary irrigation control cabinet, said plurality of secondary control valves being controlled by said primary control unit; a wiring harness being in electrical connection with said plurality of secondary control valves and said control unit; and a secondary manifold bracket to ensure proper spacing between said plurality of secondary control valves, enabling any of said plurality of secondary control valves to be removed without abutting or interference with any other of said other plurality of secondary control valves, said wiring harness extending through said secondary manifold bracket to each of said plurality of secondary control valves.

14. The irrigation control system of claim 13, wherein said enclosure includes a notch or a slot and a lift-off cover for access.

15. The irrigation control system of claim 13, wherein said irrigation control system is disposed in a sealed enclosure to enable pipes to enter and exit while essentially sealing said enclosure from small animals.

16. The irrigation control system of claim 13, wherein said manifold bracket enabling no interference with any pipes, said control box, manifold bracket or said enclosure.

17. The irrigation control system of claim 13, whereby zone, timer control, fluid consumption data, system trouble shooting and unit programming are accessed, remotely, via the cloud, smart phone, computer, laptop, tablet, or other electronic device.

18. The irrigation control system of claim 13, wherein the enclosure is made of a material selected from the group consisting of steel, aluminum, fiberglass, plastic and wood.
